(19) United States
(12) Patent Application Publication
(10) Pub. No.: US 2026/0280123 A1
(43) Pub. Date: Sep. 17, 2026

(54) ANTENNA ARRANGEMENT

(71) Applicant: Cellmax Technologies AB, Kista (SE)

(72) Inventors: Johan LUNDGREN, Storvreta (SE); Dan KARLSSON, Sollentuna (SE)

(21) Appl. No.: 19/472,664

(22) PCT Filed: Apr. 5, 2024
(86) PCT No.: PCT/SE2024/050322

§ 371 Date: Oct. 4, 2025

(30) Foreign Application Priority Data
Apr. 5, 2023 (SE) 2350398-0

(51) Int. Cl. H01Q 5/42; H01Q 19/10; H01Q 21/00

(52) U.S. Cl. CPC H01Q 5/42; H01Q 19/10; H01Q 21/0006

(57) ABSTRACT

Antenna arrangement comprising an antenna feeding network comprising first set(s) of transmission lines and second set(s) of transmission lines and set(s) of high-band radiating elements, set(s) of low-band radiating elements. The radiating elements are arranged at a front side of a backplane. Set(s) of high-band radiating element(s) is/are connected to the first set(s) of transmission lines. Set(s) of low-band radiating elements is/are connected to the second set(s) of transmission lines. The first set(s) of transmission lines is/are located at a rear side of the backplane between the backplane and a first plane parallel to the backplane. The second set(s) of transmission lines is/are located between the first plane and a second plane being parallel to the first plane.

### TECHNICAL FIELD

The present invention relates to the field of base station antennas for mobile communication.

### BACKGROUND

Base station antennas for mobile communication normally comprise an antenna feeding network, a backplane and a plurality of radiating elements (for example dipoles) arranged in front of the backplane. The backplane typically comprises an electrically conductive reflector onto which, or in front of which, the radiating elements are arranged.

Radiating elements are commonly placed as an array in front of the backplane, in some cases as a one-dimensional array extending in the vertical direction, but two-dimensional arrays are also used.

The purpose of the antenna feeding network is to distribute the signals from a common connector to all radiating elements of an array when transmitting and combining the signals from all the radiating elements to the same common connector when receiving. Such an antenna feeding network can be realized using flexible coaxial cables using e.g. PTFE as dielectric between inner and outer conductor, or air-filled coaxial lines as disclosed in WO2005/101566A1, or stripline technology with a flat conductor being placed between two ground planes, or microstrip technology using a flat conductor placed over a ground plane, or any other transmission line technology or a combination of the technologies cited above. In all those cases, it is possible to use a dielectric as e.g. PTFE between the conductor and the ground plane, or just air. The latter will result in significantly lower losses.

As the number of frequency bands used for mobile communication, e.g. as defined by 3GPP, has increased over the years, it has become advantageous to use wide-band antenna arrays which can be used for several frequency bands. One such wideband antenna array can be used for instance be used for frequency bands below 1 GHz (such as within the 600-1000 MHz range), another antenna array could be used for frequency bands within the frequency range 1-3 GHz (such as 1400-2700 MHz). Arrays for other frequency ranges could also be used. In order to reduce the number of antennas at the same site, arrays for different frequency ranges are often combined into a multi-band antenna.

Such multi-band antennas can be implemented using antenna feeding networks as disclosed in WO2005/101566A1. An example of such a multi-band antenna is disclosed in WO2014/120062A1, which antenna comprises one low-band array and two high-band arrays arranged side by side in the form of columns of radiators. The common reflector/backplane and the feeding networks are all formed from a single extruded aluminum profile.

### SUMMARY

An object of the invention is to provide an antenna arrangement having further improved performance. A further object is to provide an antenna arrangement with an antenna feeding network which is suited for feeding interleaved arrays of radiating elements, i.e. an array comprising low-band radiating elements and high-band radiating elements arranged in a common column. Such interleaved arrays are known in the art but makes the antenna feeding network more complex since the high-and low-band radiating elements are arranged close to each other along a common line/column. A further object is to provide an antenna arrangement with an antenna feeding network which is suited for feeding combined radiating elements, i.e. radiating elements having low-band radiating parts and high-band radiating parts. Such combined radiating elements, which may comprise the high-band radiating parts arranged at least partly within the low-band radiating elements to provide a compact solution are known in the art but makes the antenna feeding network more complex since the high-and low-band radiating elements are arranged close to each other, and in some cases even coaxially.

These and other objects are achieved by the present invention by means of an antenna arrangement according to the independent claim.

According to the invention, an antenna arrangement is provided, the antenna arrangement comprising an antenna feeding network, at least one set of high-band radiating elements, and at least one set of low-band radiating elements, the radiating elements being arranged at a front side of a backplane of the antenna arrangement. The high-band and/or low-band elements may be configured to radiate in more than one polarization, e.g. in two perpendicular polarizations. The antenna feeding network comprises at least one first set of transmission lines and at least one second set of transmission lines, wherein the transmission lines of the at least one first and second sets of transmission lines comprise inner and outer conductors. One or more of the at least one set of high-band radiating elements is each connected to one or more of the at least one first set of transmission lines, and one or more of the at least one set of low-band radiating elements is each connected to one or more of the at least one second set of transmission lines. The at least one first set of transmission lines is located at a rear side of the backplane between the backplane and a first plane parallel to the backplane. The at least one second set of transmission lines is located between the first plane and a second plane being parallel to the first plane.

In other words, the antenna arrangement comprises an antenna feeding network connected to at least one set of high-band radiating elements and to at least one set of low-band radiating elements, where the low-band and high-band radiating elements are arranged at a front side of a backplane (also referred to as a reflector) of the antenna arrangement, the front side referring to the side of the backplane or reflector which faces in a (main) radiation direction of the antenna arrangement. The antenna feeding network comprises at least one first set of transmission lines and at least one second set of transmission lines. The transmission lines of the antenna feeding network each comprises an inner and an outer conductor.

It is understood that a “set” of high-or low-band radiating elements refers to a number of high-or low-band elements which belong together in the sense that they are electrically interconnected. It is also understood that a “set” of transmission lines refers to a number of transmissions lines (for example coaxial lines) which belong together in the sense that they are electrically interconnected. One or more of the at least one set of high-band radiating elements is each connected to one or more of the at least one first set of transmission lines. For example, each set of high-band radiating elements may be connected to a respective first set of transmission lines. One or more of the at least one set of low-band radiating elements is each connected to one or more of the at least one second set of transmission lines. For example, each set of low-band radiating elements may be connected to a respective second set of transmission lines. It is also understood that the directions referred to in this application relate to an antenna arrangement with an antenna feeding network where a plurality of transmission lines are arranged side by side in parallel to each other and also in parallel with a backplane/reflector on (or in front of) which the radiating elements are arranged. Longitudinally in this context refers to the lengthwise direction of the transmission lines, and sideways refers to a direction perpendicular to the lengthwise direction of the coaxial lines.

The at least one first set of transmission lines is located at a rear side (i.e. opposite the above-mentioned front side) of the backplane between the backplane and a first plane parallel to the backplane. It is understood that the first plane is disposed to the rear of the backplane, i.e. at a distance from the rear side of the backplane (as seen in a rearwards direction). The at least one second set of transmission lines is located between the first plane and a second plane being parallel to the first plane. It is understood that the second plane is disposed to the rear of the first plane, i.e. at a greater distance from the rear side of the backplane (as seen in a rearwards direction) than the first plane. It is understood that the first/second plane may be defined by rear walls of the outer conductors of the first/second sets of transmission lines (in particular in embodiments where the outer conductors of the first and second sets of transmission lines are formed integrally). Alternatively, the first plane may refer to an imaginary plane between the first and second sets of transmission lines, and/or the second plane to an imaginary plane may refer to the rear of the second set of transmission lines.

Put differently, the transmission lines of the at least one first set of transmission lines are arranged in a plane being disposed at a rear side of the backplane, and the transmission lines of the at least one second set of transmission lines are arranged in another plane being disposed to the rear of the other plane, i.e. at a greater distance from the rear side of the backplane (as seen in a rearwards direction) than the plane of the first set of transmission lines. More specifically, the inner conductors of the at least one first set of transmission lines may be arranged in said plane, and the inner conductors of the at least one first set of transmission lines may be arranged in said other plane.

The invention is based on the insight that by providing first set(s) of transmission lines connected to the high-band elements, and second set(s) of transmission lines connected to the low-band elements, where the first set(s) of transmission lines are arranged to the front of the second set(s) of transmission lines, the first set(s) of transmission lines are arranged close to the high-band radiating elements which requires short connectors thereto, this being particularly advantageous at high frequencies. The invention is further based on the insight that by providing the first and second sets of transmission lines in separate planes in front/behind each other, it is possible to connect radiating elements positioned along a common line/array (such as radiating elements of an interleaved column/array and/or combined radiating elements) to transmission lines of both sets of transmission lines, i.e. high-band radiating elements are connected to the first set(s) of transmission lines and low-band radiating elements are connected to the second set(s) of transmission lines being arranged behind the first set(s), for instance via coupling elements extending through the first set(s) of transmission lines. The invention is further based on the insight that, due to the low frequencies, the coupling elements required to connect the low-band radiating elements to the second set(s) of transmission lines provide satisfactory performance despite their relatively longer length.

The space formed between the inner and the outer conductor may be substantially air-filled. The outer conductor of at least one transmission line may at least partially surround the inner conductor. The first and second sets of transmission lines may comprise parallel coaxial lines, each having its inner conductor at least partly surrounded by the outer conductor with air therebetween. The inner conductor of at least one transmission line may have a polygon-shaped cross section. The polygon-shape may have any number of segments, such as four segments (substantially rectangular cross section for example) or an infinite number of segments (circular cross section for example). Alternatively, the first and/or second sets of transmission lines may comprise at least one transmission line each comprising at least one ground plane forming at least part of the outer conductor and a flat inner conductor forming the inner conductor, the inner conductor interacting with the at least one ground plane. The flat inner conductors may each be placed in a respective compartment having conducting walls, the flat inner conductors interacting with two ground planes formed by said conducting walls.

In embodiments, at least one, or each, transmission line is provided with at least one support element configured to support the central inner conductor, the support element being located between the outer and inner conductors. The support element(s) may be supported by the outer conductor to define the positional relationship between the inner and outer conductors.

In embodiments, at least two low-band radiating elements and at least two high-band radiating elements are arranged in a column to form an interleaved array of radiating elements. At least two of the low-band radiating elements may be connected to one or more inner conductors of transmission lines of the second set of transmission lines via at least one (such as two) low-band coupling element for each low-band radiating element, wherein at least one pair of consecutive high-band radiating elements are connected to at least one (such as two) common inner conductor of one or more transmission lines of the first set of transmission lines, each transmission line(s) for at least one pair of high-band radiating elements being arranged between two of said low-band coupling elements. The two low-band coupling elements may be arranged to connect two consecutive low-band radiating elements to a common inner conductor of a transmission line of the second set of transmission lines.

The above-mentioned embodiment may additionally or alternatively be described in that at least two of the high-band radiating elements are connected to inner conductors of transmission lines of the first set of transmission lines via at least one high-band coupling element for each high-band radiating element, and at least two of the low-band radiating elements are connected to inner conductors of transmission lines of the second set of transmission lines via at least one low-band coupling element for each low-band radiating element, wherein low-band coupling element(s) of at least one low-band radiating element is arranged between high-band coupling elements of two consecutive high-band radiating elements and/or at least one high-band coupling element is arranged between low-band coupling elements of two consecutive low-band radiating elements.

In embodiments, at least two low-band radiating elements and at least two, or at least three, high-band radiating elements are arranged in a column to form an interleaved array of radiating elements. At least two of the low-band radiating elements may be connected to one or more inner conductors of transmission lines of the second set of transmission lines via at least one (such as two) low-band coupling element for each low-band radiating element, wherein at least two, or at least three, consecutive high-band radiating elements are connected to at least two inner conductors of one or more transmission lines of the first set of transmission lines, each inner conductor/transmission line for the at least two, or at least three, consecutive high-band radiating elements being arranged between two of said low-band coupling elements. The at least two, or at least three, consecutive high-band radiating elements may each be connected to a respective consecutive inner conductor of at least two, or at least three, transmission lines of the first set of transmission lines. The inner conductors/transmission lines for the at least two, or at least three, consecutive high-band radiating elements may be arranged between two low-band coupling elements connecting two consecutive low-band radiating elements to a common inner conductor of a transmission line of the second set of transmission lines.

At least one high-band radiating element of the at least two, or at least three, high-band radiating elements may be formed together with a low-band radiating element as a combined radiating element having low-band radiating parts and high-band radiating parts.

The first and/or second sets of transmission lines may comprise parallel coaxial lines, each having its inner conductor at least partly surrounded by the outer conductor with air therebetween. Alternatively, the first and/or second sets of transmission lines may comprise at least one transmission line each comprising at least one ground plane forming at least part of the outer conductor and a flat inner conductor forming the inner conductor, the inner conductor interacting with the at least one ground plane. The flat inner conductors may each be placed in a respective compartment having conducting walls, the flat inner conductors interacting with two ground planes formed by said conducting walls.

In the embodiments above, it is understood that inner conductor(s) or coupling element(s) being arranged between two coupling elements implies that they are physically between said two coupling elements, for example in the sense that the inner conductor(s) or coupling element(s) and the two coupling elements extend into or through one and the same outer conductor or compartment of the antenna feeding network and the inner conductor(s) or coupling element(s) is/are arranged between the two coupling elements in said outer conductor or compartment.

In the above-described embodiments comprising high-band radiating elements connected to inner conductors of transmission lines of the first set of transmission lines via respective high-band coupling elements, and low-band radiating elements connected to inner conductors of transmission lines of the second set of transmission lines via respective low-band coupling elements, one or at least one high-band radiating element (which may be of at least one pair of the high-band radiating elements being pairwise connected) is/are formed together with a low-band radiating element (which may be of at least one pair of the low-band radiating elements being pairwise connected) as a combined radiating element having low-band radiating parts and high-band radiating parts. The low-band radiating parts and high-band radiating parts of at least one combined radiating element may be coaxially arranged. The high-band radiating elements may be arranged at least partly within the low-band radiating parts, e.g. at least partly within a space formed by a convexly shaped, such as a bowl-shaped, body of the low-band radiator.

In embodiments, the antenna feeding network further comprises at least one first connector device interconnecting inner conductors of at least two transmission lines of the first set of transmission lines, and at least one second connector device interconnecting inner conductors of at least two transmission lines of the second set of transmission lines, wherein the antenna arrangement is provided with openings in the outer conductors of the at least two transmission lines of the first set of transmission lines for each first connector device at said front side of the backplane, and wherein the antenna arrangement is provided with openings in the outer conductors of the at least two transmission lines of the second set of transmission lines for each second connector device at a rear side of the second set of transmission lines. This advantageous embodiment is based on the insight that since the first set(s) of transmission lines are arranged to the front of the second set(s) of transmission lines, openings in the outer conductors necessary to interconnect the transmission lines may be provided in an advantageous manner which minimizes unwanted radiation in a backwards direction from the antenna arrangement. Part of this insight lies in the understanding that unwanted radiation through such openings increases at higher frequencies since the wavelength is shorter in relation to the dimensions of the openings. Consequently, by arranging the first set(s) of transmission lines connected to the higher-frequency high-band elements to the front of the second set(s) of transmission lines connected to the low-band elements, the opening(s) at the rear side of the antenna arrangement will be associated with the second set(s) of transmission lines causing a low amount of unwanted radiation backwards due to the low frequency. The opening(s) at the front/reflector side of the antenna arrangement will be associated with the first set(s) of transmission lines, which although causing unwanted radiation, is directed forwards in the radiation direction rather than backwards.

In embodiments, the at least one first connector device is configured to interconnect inner conductors of at least two transmission lines of the first set of transmission lines capacitively and/or inductively, or alternatively galvanically. The at least one second connector device may be configured to interconnect inner conductors of at least two transmission lines of the second set of transmission lines capacitively and/or inductively, or alternatively galvanically. Such capacitive and/or inductive connection may be achieved by means of an insulating layer or coating arranged on the connector device and/or on the inner conductor(s) and/or in the form of an insulating film between the connector device and the inner conductor(s).

Capacitive and/or inductive connection in antenna feeding networks is described in more detail in applicant's application WO2017048185, which is hereby incorporated by reference.

In embodiments, the antenna arrangement comprises at least one combined radiating element, each combined radiating element having low-band radiating parts and high-band radiating parts such as to form one of the high-band radiating elements and one of the low-band radiating elements.

In embodiments, the set of high-band radiating elements is configured to transmit and receive signals within one or more first frequency bands, the set of low-band radiating elements being configured to transmit and receive signals within one or more second frequency bands having a center frequency F₂ being lower than a center frequency F₁ of said one or more first frequency bands. The ratio F₁:F₂ may be larger than 1.5:1, or larger than 2:1. For example, the set of high-band radiating elements may be configured to transmit and receive signals within one or more first frequency bands being within the interval 1-3 GHz and the set of low-band radiating elements being may be configured to transmit and receive signals within one or more second frequency bands being within the interval 600-1000 MHz. The center frequencies may thus for example be F₁=2 GHz and F₂=800 MHz thus resulting in a ratio F₁:F₂ of about 2.5:1.

In embodiments, the antenna arrangement further comprises a phase shifting arrangement being at least partly arranged within one or more outer conductors of at least one transmission line of the first and/or second set of transmission lines. The phase shifting arrangement may comprise at least one dielectric element being slidably arranged in said one or more outer conductors.

In embodiments, at least one, or each, transmission line of the first and/or second set of transmission lines is provided with an elongated rail element slidably arranged inside its outer conductor, the rail element being longitudinally movable in relation to said outer conductor, the elongated rail element being provided with at least one dielectric element configured to co-operate with the transmission line to provide a phase shifting arrangement.

In embodiments where at least one, or each, transmission line of the second set of transmission lines is provided with such elongated rail element(s), the rail element may be arranged in a front portion of the compartment formed by the outer conductor. The front portion may be defined as the portion of the compartment being closest to the first plane. The antenna arrangement may further comprise means for adjusting the position(s) of at least one, or each of, the rail element(s), the means for adjusting comprising a first connecting element slidably arranged in the outer conductor and being connected to the rail element, and a second connecting element connected to the first connecting element by means of extending through at least one longitudinally extending slot in the outer conductor. These embodiments having the rail element(s) arranged in front portion(s) of the compartments of the second set(s) of transmission lines are advantageously combined with the above-described embodiments where the antenna arrangement is provided with opening(s) for second connector device(s) at a rear side of the second set(s) of transmission lines. Since the rail element(s) are arranged in front portion(s) of the compartments, they do not obstruct the openings at the rear side of the second set(s) of transmission lines.

In embodiments where at least two transmission lines of the second set of transmission lines is provided with the above-described rail elements, the means for adjusting may comprise a longitudinally extending rod, wherein each second connecting element is provided with an internally threaded portion, the internally threaded portions being configured to co-operate with corresponding (externally) threaded segments or portions of the rod, wherein the threaded segments or portions of the rod have different pitch from each other such that the second connecting elements of the two transmission lines move at different speed when the rod is rotated.

In embodiments wherein at least one, or each, transmission line of the first set of transmission lines is provided with said elongated rail element, the rail element may be arranged at a rear portion of the compartment formed by the outer conductor, the antenna arrangement comprising means for adjusting the position of said rail element, wherein the means for adjusting comprises a third connecting element connected to the rail element by means of extending through a longitudinally extending slot of the outer conductor and through longitudinally extending slots in an adjacent outer conductor of a transmission line of the second set of transmission lines.

In embodiments where at least two transmission lines of the first set of transmission lines is provided with the above-described rail elements, the means for adjusting may comprise a longitudinally extending rod, wherein each third connecting is provided with an internally threaded portion, the internally threaded portions being configured to co-operate with corresponding (externally) threaded segments or portions of the rod, wherein the threaded segments or portions of the rod have different pitch from each other such that the third connecting elements of the two transmission lines move at different speed when the rod is rotated.

The means for adjusting may further comprise means for manually rotating said longitudinally extending rod, for example a handle or knob, such that the rod may be rotated or actuated by hand. Alternatively, the means for adjusting may comprise at least one electric motor arranged to rotate said longitudinally extending rod. The means for adjusting may also comprise means for electrically controlling said electric motor from a distance, which may comprise a communication circuitry connectable to an external controller, a controller such as a microcontroller and a motor driver circuit. One electric motor may be configured to control several antenna arrays/sets of radiating elements. The communication circuit may be protected against surges which may have been provoked by e.g. lightnings. Such embodiments are advantageous since it is possible to remotely change the position of the dielectric elements, thus remotely controlling the electrical downtilt of the antenna.

The features of the embodiments described above are combinable in any practically realizable way to form embodiments having combinations of these features.

### BRIEF DESCRIPTION OF THE DRAWINGS

Above discussed and other aspects of the present invention will now be described in more detail using the appended drawings, which show presently preferred embodiments of the invention, wherein:

FIG. 1 shows a partial cross-section view of an embodiment of the antenna arrangement according to the invention, the cross-section being taken along a plane being perpendicular to the longitudinal/height direction of the antenna arrangement;

FIG. 2 shows a partial cross-section view of the embodiment in FIG. 1, the cross-section being taken along a plane being parallel with the longitudinal/height direction of the antenna arrangement;

FIG. 3 shows a front view of the embodiment in FIG. 1-2;

FIGS. 4-5 show two partial cross-section views of different parts of the antenna feeding network of the embodiment in FIG. 1-3, the cross-sections being taken along planes being perpendicular to the longitudinal/height direction of the antenna arrangement;

FIG. 6 shows a detail view of the first set of transmission lines of another embodiment of the antenna arrangement according to the invention;

FIG. 7 shows a partial cross-section view of yet another embodiment of the antenna arrangement according to the invention, the cross-section being taken along a plane being perpendicular to the longitudinal/height direction of the antenna arrangement;

FIG. 8 shows a partial cross-section view of an alternative embodiment of the antenna arrangement according to the invention, the cross-section being taken along a plane being parallel with the longitudinal/height direction of the antenna arrangement;

FIG. 9 shows a schematic front view of the embodiment in FIG. 8 with the backplane/reflector made transparent;

FIG. 10 shows a partial cross-section view of yet an alternative embodiment of the antenna arrangement according to the invention, the cross-section being taken along a plane being parallel with the longitudinal/height direction of the antenna arrangement;

FIG. 11 shows a schematic front view of the embodiment in FIG. 10 with the backplane/reflector made transparent;

FIG. 12 shows a front view of the embodiment in FIG. 8-9/10-11;

FIG. 13 shows a partial cross-section view of yet another embodiment of the antenna arrangement according to the invention, the cross-section being taken along a plane being perpendicular to the longitudinal/height direction of the antenna arrangement, and

FIG. 14 shows a partial cross-section view of the embodiment FIG. 13, the cross-section being taken along a plane being parallel with the longitudinal/height direction of the antenna arrangement.

### DETAILED DESCRIPTION

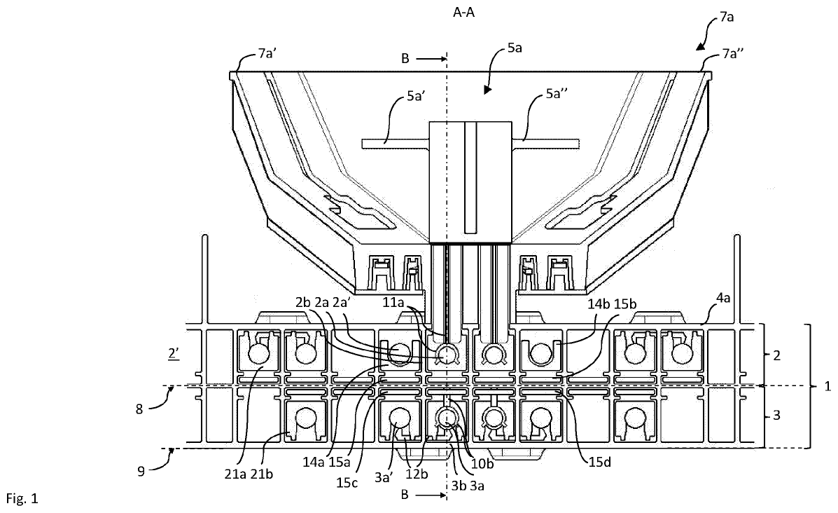

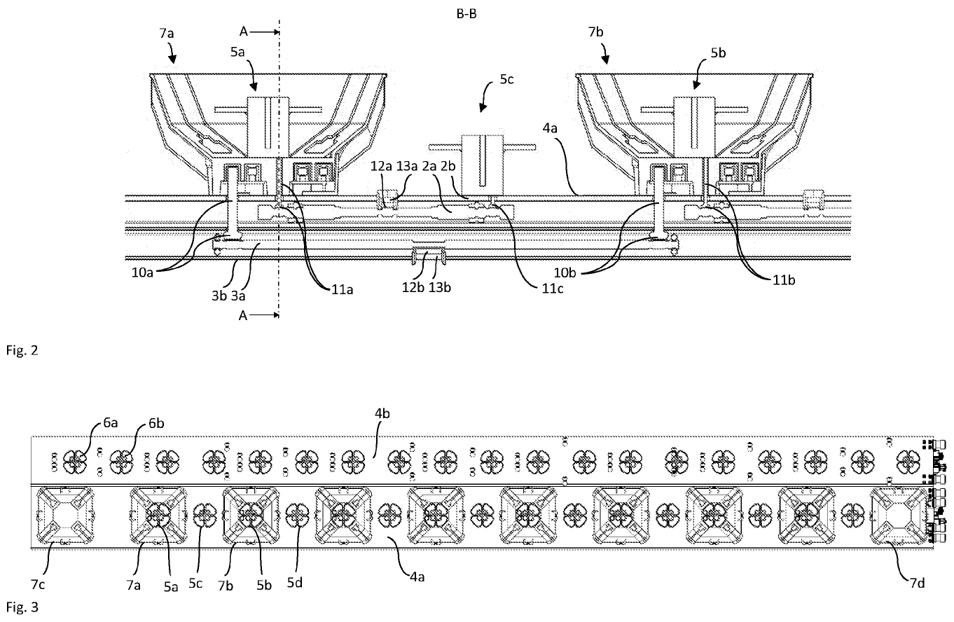

FIGS. 1-5 show an embodiment of the antenna arrangement according to the invention. In FIG. 1, a partial cross-section view of the antenna arrangement is shown, the cross-section being taken along a plane A-A being perpendicular to the longitudinal/height direction of the antenna arrangement (see FIG. 2). In FIG. 2 a partial cross-section view of the embodiment in FIG. 1 is shown, the cross-section being taken along a plane B-B being parallel with the longitudinal/height direction of the antenna arrangement (see FIG. 1). FIG. 3 shows a front view of the embodiment in FIG. 1-2.

With reference to FIG. 1-3, the antenna arrangement comprises an antenna feeding network 1 comprising a first set of transmission lines 2 and a second set of transmission lines 3. The transmission lines of the first and second sets of transmission lines comprises inner conductors (2a, 3a for example) and outer conductors (2b, 3b for example) forming coaxial lines. The inner conductors have circular cross sections and are surrounded by a respective outer conductor having a substantially rectangular cross-section.

The space formed between each inner conductor (2a, 3a for example) and the corresponding outer conductor (2b, 3b for example) is substantially air-filled in the sense that solely air is provided between the inner and outer conductors except for support elements (21a-b for example) configured to hold the inner conductors in position, connector devices (12a-b for example, described below), rail elements (15a-b for example, described below) and dielectric elements (14a-b for example, described below).

The first set of transmission lines 2 is located at a rear side of the backplane 4a between the backplane and a first plane 8 parallel to the backplane. The second set of transmission lines 3 is located between the first plane and a second plane 9 being parallel to the first plane.

The antenna arrangement comprises a first set of high-band radiating elements (5a-d for example), and a set of low-band radiating elements (7a-d for example), the radiating elements being arranged at a front side of a backplane/reflector 4a. The high-and low-band radiating elements are dual-polarized and/or cross-polarized. Each polarization is connected to a first or a second set of transmission lines using one coupling element.

A plurality (eight in this embodiment) of the first set of high-band radiating elements (5a-b for example) and of the set of low-band radiating elements (7a-b for example) are formed as combined radiating elements, each combined radiating element having low-band radiating parts (7a′, 7a″ for example) and high-band radiating parts (5a′, 5a″ for example) such as to form one of the high-band radiating elements (5a-b for example) and one of the low-band radiating elements (7a-b for example).

The first set of high-band radiating elements also comprises high-band-only radiating elements (5c-d for example). The set of low-band radiating elements also comprises low-band-only radiating elements (7c-d for example). Other embodiments correspond to the embodiment in FIG. 1-3 except that the low-band-only radiating elements are omitted.

The first sets of high-band and low-band radiating elements are arranged in a column/along a straight line to form an interleaved array of radiating elements (see FIG. 3).

The set of high-band radiating elements 5a-d is configured to transmit and receive signals within one or more first frequency bands and the set of of low-band radiating elements 7a-d is configured to transmit and receive signals within one or more second frequency bands having a center frequency F₂ being lower than a center frequency F₁ of said one or more first frequency bands. The ratio F₁:F₂ is larger 1.5:1.

The first set of high-band radiating elements is connected to the first set of transmission lines 2 via high-band coupling elements (11a-b for example) connecting to the inner conductors thereof. The set of low-band radiating elements is connected to the second set of transmission lines 3 via low-band coupling elements (10a-b for example) connecting to the inner conductors thereof. The low-band/high-band radiating elements are connected to the respective inner conductors capacitively and/or inductively. This is achieved by means of an insulating layer or coating arranged on the coupling elements and/or on the inner conductors and/or in the form of an insulating film between the coupling elements and the inner conductors.

A plurality of consecutive low-band radiating elements (7a-b for example) of the combined radiating elements are connected pairwise to common inner conductors (3a for example, see FIG. 2) of transmission lines of the second set of transmission lines 3 via two respective low-band coupling elements (10a-b for example) for each low-band radiating element. Consecutive high-band radiating elements (5a, 5c for example) are connected pairwise to common inner conductors (2a for example, see FIG. 2) of respective transmission lines of the first set of transmission lines 2. The inner conductor 2a for the pair of high-band radiating elements 5a, 5c is arranged between two of the low-band coupling elements 10a-b for the pairwise connected low-band radiating elements. The other inner conductor (not seen in the figure) for the pair of high-band radiating elements 5a, 5c is arranged between the other two of the low-band coupling elements (not seen in the figure) for the pairwise connected low-band radiating elements. In other embodiments with different network topologies, one or more of the low-band radiating elements may be connected individually to a transmission line (i.e. not pairwise with another low-band radiating element as described above).

As can be seen in FIG. 3, the antenna arrangement comprises an additional set of high-band radiating elements (6a-b for example) being similar as the high-band radiating elements 5c-d. The additional set of high-band radiating elements are arranged in a column in front of a backplane 4b and in parallel with the column of radiating elements 5a-d, 7a-c arranged in front of backplane 4a. The backplanes 4a, 4b are formed integrally with each other and with the outer conductors of the feeding network as an extruded aluminum profile and may thus also be referred to as backplane portions or reflector portions. Part of the antenna feeding network for the additional set of high-band radiating elements can be seen to left in FIG. 1 (part of two other conductors). The additional set of high-band radiating elements 6a-b is connected to an additional first set of transmission lines 2′ located at a rear side of the backplane 4b between the backplane and the first plane 8 (corresponding to the first set of transmission lines 2 connected to high-band radiating elements 5a-d). It is understood that the lower set of outer conductors (below the additional first set of transmission lines 2′, corresponding to the outer conductors of the second set of transmission lines 3) are not populated with inner conductors (since no low-band radiating elements are provided). In other words, there is no additional second set of transmission lines to the rear of the additional first set of transmission lines 2′. In other embodiments, the lower set of outer conductors (below the additional first set of transmission lines 2′) are omitted altogether. Although integrally formed, the two arrays form separate antennas, one being a high-band antenna (4b, 6a-b) and the other a combined low-band/high-band antenna (4a, 5a-d, 7a-c). The coaxial connectors for the two antennas can be seen to the right in FIG. 3.

The antenna feeding network further comprises first connector devices (12a for example, see FIG. 2) interconnecting inner conductors (2a, 2a′ for example, see FIG. 1) of the first set of transmission lines 2, and at least one second connector device (12b for example) interconnecting inner conductors (3a, 3a′) of the second set of transmission lines 3. The antenna arrangement is provided with an opening 13a for each first connector device at the front side of the backplane 4a. The antenna arrangement is also provided with an opening 13b for each second connector device 12b at a rear side of the second set of transmission lines. The connector devices 12a, 12b are configured to interconnect the respective inner conductors capacitively and/or inductively.

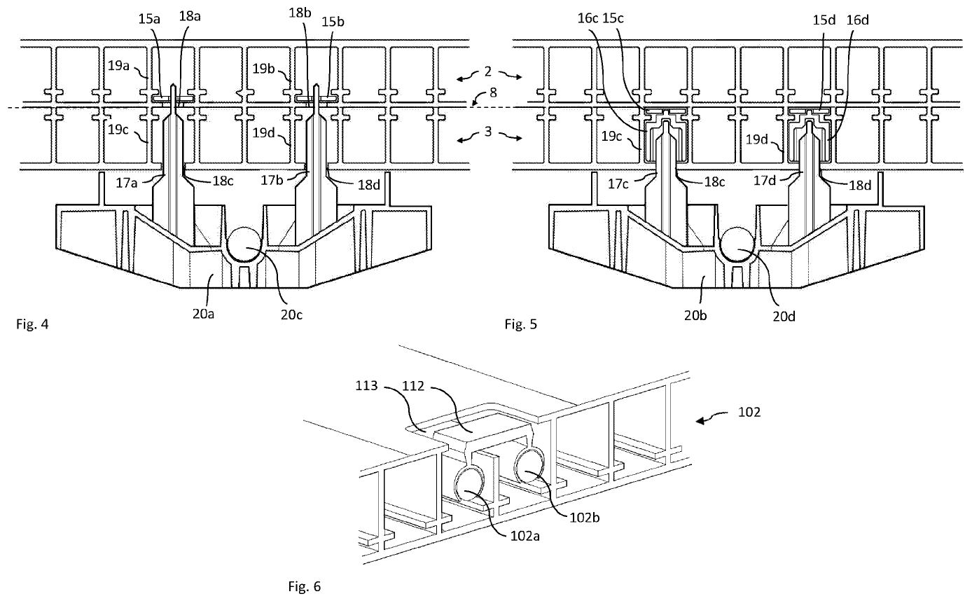

FIG. 4-5 show two partial cross-section views of different parts of the antenna feeding network of the embodiment in FIG. 1-3, the cross-sections being taken along planes being perpendicular to the longitudinal/height direction of the antenna arrangement. The antenna feeding network is shown in FIG. 4-5 without inner conductors.

FIGS. 1 and 4-5 show parts of phase shifting arrangements of the first and second sets of transmission lines, each phase shifting arrangement comprising elongated rail elements (15a-d for example) slidably arranged inside the respective outer conductor (19a-d for example), the rail element being longitudinally movable in relation to said outer conductor, the elongated rail element being provided with U-shaped dielectric elements (14a-b for example) configured to co-operate with the transmission line to provide a phase shifting arrangement. The second set of transmission lines 3 is provided with the elongated rail elements 15c-d arranged in front portion of the compartment formed by the outer conductor (19c-d, see FIG. 5), the front portion being the portion of the compartment being closest to the first plane 8. The first set of transmission lines 2 is provided with the elongated rail elements 15a, 15b arranged at a rear portion of the compartment formed by the outer conductor 19a, 19b.

The phase shifting arrangement comprises means for adjusting the position of the rail elements, wherein the means for adjusting comprising first connecting elements 16c-d slidably arranged in respective outer conductors 19c-d of the second set of transmission lines and being connected to the respective rail element 15c-d, and a second connecting element 17c-d connected to the respective first connecting element by means of extending through longitudinally extending slots 18c, 18d in the outer conductor 19c-d. The means for adjusting further comprises third connecting elements 17a-b connected to a respective rail element 15a-b by means of extending through a longitudinally extending slot 18a-b of its outer conductor and through longitudinally extending slots 18c-d in an adjacent outer conductor of a transmission line of the second set of transmission lines 3.

The connecting elements 17a-b are in turn connected to, or form part of, a displacement member 20a which is displaceable in the longitudinal direction of the antenna arrangement. Correspondingly, the connecting elements 17c-d are connected to, or form part of, a displacement member 20b which is displaceable in the longitudinal direction of the antenna arrangement. Displacement members 20a, 20b are arranged consecutively/spaced apart in the longitudinal direction of the antenna arrangement.

The displacement members 20a, 20b are each provided with an internally threaded portion in which a respective threaded rod 20c, 20d is fitted. The threaded rod may be provided with means for manual rotation thereof, for example a handle or knob, such that the rod may be rotated or actuated by hand. Alternatively, one electric motor may be arranged to rotate the longitudinally extending rod 20c and another electric motor can be arranged to rotate the longitudinally extending rod 20d. In another alternative, one common electric motor is used which is arranged to rotate either rod 20c or rod 20d using a mechanical switch mechanism. When using electric motors, the rails, and hence the electrical tilt of the antenna, can be controlled remotely. The remote control can be achieved by communication circuitry connectable to an external controller e.g. by connecting the motor, a motor driver circuit and a micro-controller to a cellular base station, or some other means for control. The communication circuit may be protected against surges which may have been provoked by e.g. lightnings and can be common for two or more electric motors in the antenna, or there can be more than one communication circuit connected to one or more electric motor. It is understood that the above references to rail elements 15a-d arranged in outer conductors 19a-d are only exemplary figure references and that further rail elements and dielectric elements are normally used in order to achieve an antenna feeding network having adjustable electrical tilt angle. Applicant's earlier publication WO 2017/048184 (which is hereby included by reference) describes the function of an antenna feeding network having rail elements and dielectric elements in a plurality of coaxial lines to achieve adjustable electrical tilt (see FIG. 9 for example). The teachings therein can be applied to the first and second sets of transmission lines, although combined with the inventive solution comprising first, second and third connecting elements and elongated rail elements of the second set of transmission lines being arranged in front portions of the respective outer conductors.

FIG. 6 shows a detail view of the first set of transmission lines of another embodiment of the antenna arrangement according to the invention. In this figure only the first set of transmission lines are shown. A first connector device 112 is shown (corresponding to ref. 12a in FIG. 2) interconnecting inner conductors 102a-b. The antenna arrangement is provided with an opening 113 for the first connector device 112 at the front side of the reflector/backplane. The connector device 112 (as well as connector devices 12a-b in FIG. 2) are realized as snap on elements comprising a pair of snap on fingers and a bridge portion (as can be seen in FIG. 6), wherein the snap on fingers are configured to be snapped onto the inner conductors. The connector device 112 (as well as connector devices 12a-b in FIG. 1-2) is configured to interconnect the respective inner conductors capacitively and/or inductively by means of an insulating layer on the connector device.

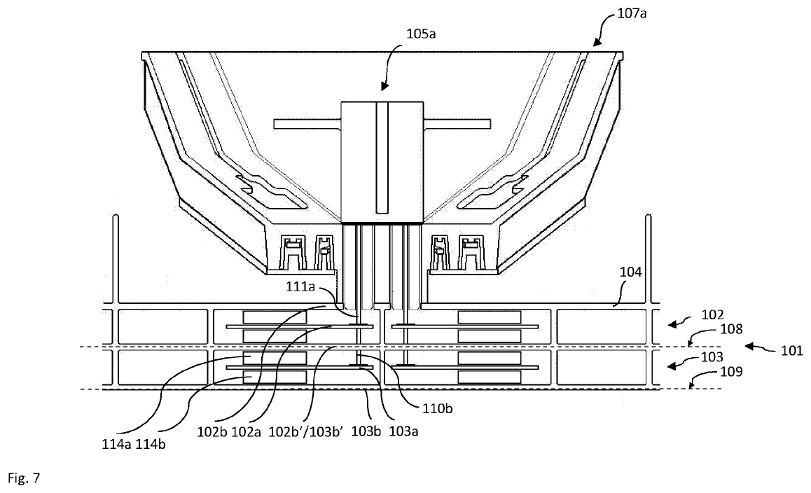

FIG. 7 shows a partial cross-section view of yet another embodiment of the antenna arrangement according to the invention, the cross-section being taken along a plane being perpendicular to the longitudinal/height direction of the antenna arrangement. The embodiment corresponds to the embodiment shown in FIG. 1-5 in the sense that it comprises the same sets of radiating elements (high-band radiating element 105a and low-band radiating element 107a corresponding to ref. 5a/7a in FIG. 1-3 can be seen in FIG. 7), but differs in that the antenna feeding network 101 comprises flat inner conductors (striplines). The first set of transmission lines 102 is located at a rear side of the backplane 104 between the backplane and a first plane 108 parallel to the backplane. The second set of transmission lines 103 is located between the first plane and a second plane 109 being parallel to the first plane. The first set of transmission lines 102 comprises transmission lines each comprising a flat inner conductor (102a for example) forming inner conductors, the flat inner conductors being placed in a respective compartment having conducting walls, the flat inner conductors interacting with two ground planes (102b, 102b′ for example) formed by said conducting walls. The second set of transmission lines 103 comprises transmission lines each comprising a flat inner conductor (103a for example) forming inner conductors, the flat inner conductors being placed in a respective compartment having conducting walls, the flat inner conductors interacting with two ground planes (103b, 103b′ for example) formed by said conducting walls. The flat inner conductors/striplines have the same function as the coaxial lines in FIG. 1-5. The spaces between the flat conductors/strips and the ground planes are substantially air filled. The first set of high-band radiating elements (105a for example) is connected to the first set of transmission lines 102 via coupling elements (111a for example) connecting to the flat inner conductors thereof. The set of low-band radiating elements (107a for example) is connected to the second set of transmission lines 103 via coupling elements (110b for example) connecting to the flat inner conductors thereof. Dielectric elements (114a, 114b for example) are arranged in the compartments and form part of a phase shifting arrangement for adjusting the electrical tilt of the antenna arrangement.

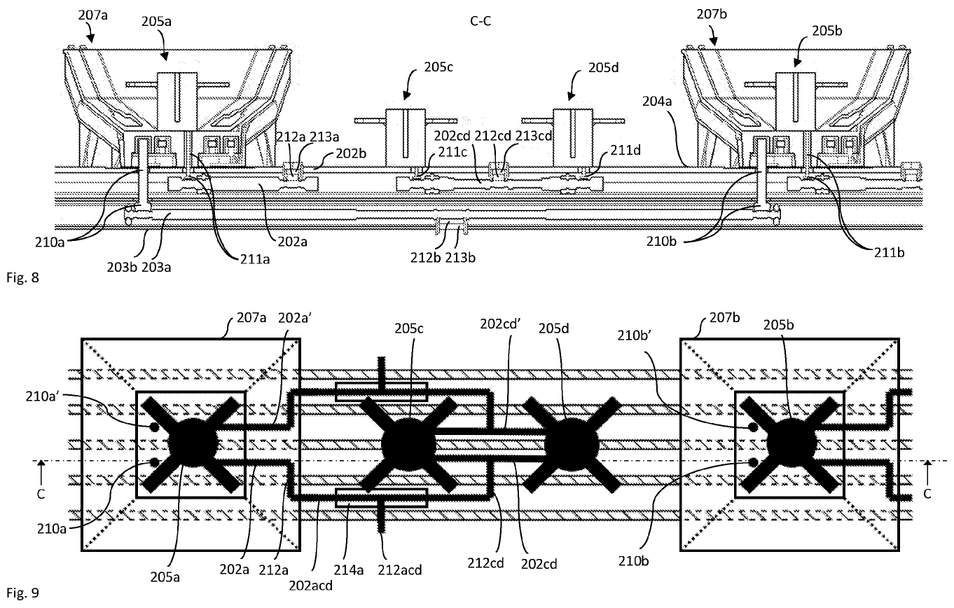

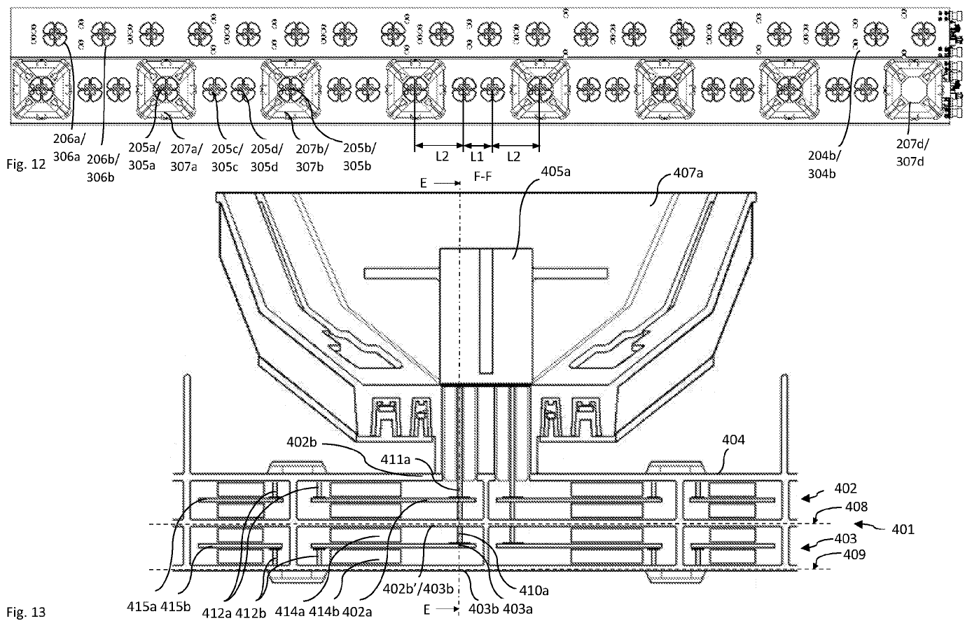

FIG. 8 shows a partial cross-section view of an alternative embodiment of the antenna arrangement according to the invention, the cross-section being taken along a plane C-C (see FIG. 9) being parallel with the longitudinal/height direction of the antenna arrangement. FIG. 9 shows a schematic partial front view of the embodiment in FIG. 8 with the backplane/reflector made transparent. FIG. 12 shows a front view of the embodiment in FIG. 8-9 (except that the openings for interconnecting inner conductors of the first set of transmission lines are not shown).

This embodiment corresponds to the embodiment in FIG. 1-3, in that it comprises components 202b, 203a-b, 204a-b, 205a-b, 206a-b, 207a-b, 207d, 210a-b, 212b, 213b corresponding to 2b, 3a-b, 4a-b, 5a-b, 6a-b, 7a-b, 7d, 10a-b, 12b, 13b in FIG. 1-3. The description above regarding these components with reference to FIG. 1-3 applies in a corresponding manner to FIGS. 8, 9 and 12. Furthermore, the first and second sets of transmission lines are located in relation to each other and in relation to the backplane 204a in a corresponding manner as described above with reference to FIG. 1-3.

This embodiment differs from FIG. 1-3 in that it:
comprises two high-band only radiating elements (205c, 205d for example) between each consecutive pair of combined high-band/low-band radiating elements (205a/207a, 205b/207b for example), and only one low-band only radiating element (207d). Thus, there are more high-band radiating elements and fewer low-band elements in this column, and
the first set of transmission lines is of the same air-filled coaxial type as in FIG. 1-3, but the configuration differs due to the different number of high-band only radiating elements.

The high-band only radiating elements (205c-d for example) are of the same type as 5c described above with reference to FIG. 1-3.

The first set of high-band radiating elements (205a-d for example) is connected to the first set of transmission lines 2 via high-band coupling elements (211a-d for example) connecting to the inner conductors thereof. The high-band radiating elements are connected to the respective inner conductors capacitively and/or inductively. This is achieved by means of an insulating layer or coating arranged on the coupling elements and/or on the inner conductors and/or in the form of an insulating film between the coupling elements and the inner conductors.

Consecutive high-band only radiating elements (205c-d for example) arranged between consecutive combined radiating elements (205a/207a, 205b/207bfor example) are connected pairwise to common inner conductors (202cd for example, see FIG. 8-9) of respective transmission lines of the first set of transmission lines. High-band radiating elements (205a for example) being part of a combined radiating element are connected to a respective/individual inner conductor (202a for example) of the first set of transmission lines.

The inner conductor 202cd for the pair of high-band only radiating elements 205c-d and the inner conductor 202a for the high-band radiating element 205a are arranged between two of the low-band coupling elements 210a-b for the pairwise connected (consecutive) low-band radiating elements. Put differently, the transmission lines (including the respective portion of outer conductor 202b) for the high-band radiating elements 205a, 205c-d are arranged between the low-band coupling elements 210a-b.

The antenna feeding network further comprises first connector devices (212a, 212cd for example, see FIG. 8-9) interconnecting inner conductors (202a, 202cd, 202acd for example, see FIG. 9) of the first set of transmission lines. As can be seen in FIG. 9, a further connector device 212acd is connected to inner conductor 212acd to act as a two-way splitter/combiner splitting signals to the high-band radiating elements 205a, 205c-d or combining signals received from said high band elements. Further as can be seen in FIG. 9, dielectric elements (214a for example) being displaceable by elongated rail elements in a corresponding manner as described with reference to FIG. 1 and 4-5. The dielectric elements are U-shaped in a corresponding manner as shown in FIG. 1.

The antenna arrangement is provided with openings (213a, 213cd for example) for each first connector device at the front side of the backplane 204a. The antenna arrangement is also provided with an opening (213b for example) for each second connector device (212b for example) at a rear side of the second set of transmission lines. The connector devices 212a, 212cd, 212b are configured to interconnect the respective inner conductors capacitively and/or inductively.

As can be seen in FIG. 12, the distance L2 between each high-band only radiating element and the adjacent high-band radiating element of a combined radiating element is greater than the distance L1 between two high-band only radiating elements. This is advantageous to reduce the influence on the high-band only radiating elements radiation diagram by the adjacent low-band radiating element of the combined radiating element.

Feeding networks for both polarizations of the dual polarized high band radiating elements are shown in FIG. 9, but the description above only describes the feeding network for one polarization as the function of the other side of the feeding network (for the other polarization) can be understood by analogy. For example, the second inner conductors 202a′, 202cd′ of the other side of the feeding network connected to high-band radiating elements 205a, 205c-d are arranged between two of the (second) low-band coupling elements 210a′-b′ of the other side of the feeding network connected to the pairwise connected (consecutive) low-band radiating elements.

In other embodiments with different network topologies, one or more of the low-band radiating elements may be connected individually to a transmission line (i.e. not pairwise with another low-band radiating element as described above).

Other embodiments correspond to the embodiment in FIGS. 8, 9, 12 except that the low-band-only radiating element 207d is omitted.

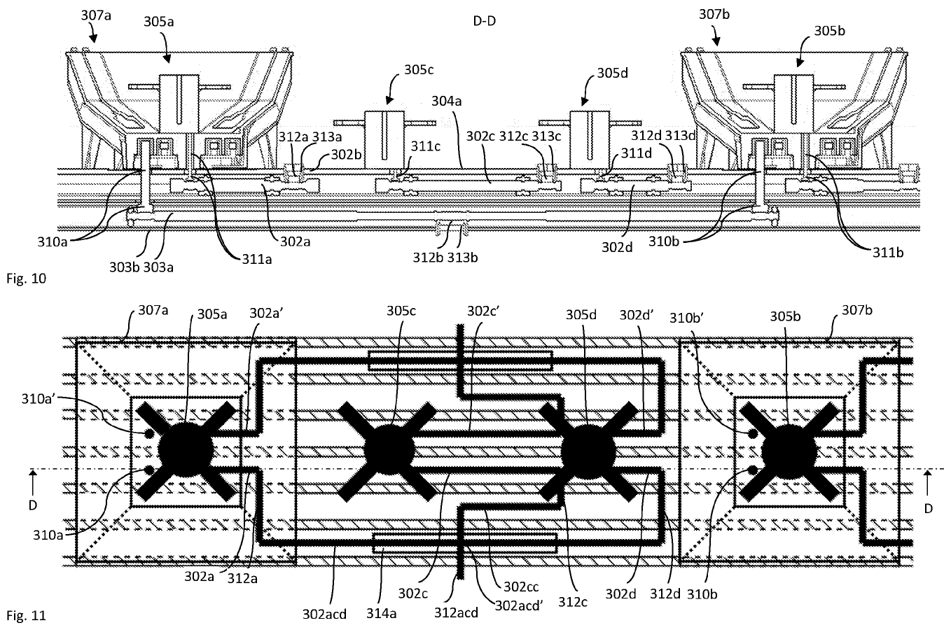

FIG. 10 shows a partial cross-section view of yet an alternative embodiment of the antenna arrangement according to the invention, the cross-section being taken along a plane D-D (see FIG. 11) being parallel with the longitudinal/height direction of the antenna arrangement. FIG. 11 shows a schematic front view of the embodiment in FIG. 10 with the backplane/reflector made transparent.

This embodiment corresponds to the embodiment in FIGS. 8, 9, 12 in that it comprises components 302b, 303a-b, 304a-b, 305a-d, 306a-b, 307a-b, 307d, 310a-b, 312b, 313b corresponding to 202b, 203a-b, 204a-b, 205a-d, 206a-b, 207a-b, 207d, 210a-b, 212b, 213b in FIGS. 8, 9, 12. The description above regarding these components with reference to FIGS. 8, 9, 12 applies in a corresponding manner to FIG. 10-11.

This embodiment however differs from FIGS. 8, 9, 12 in that the first set of transmission lines is configured differently, as will be explained in the following.

The high-band radiating elements (305a, 305c, 305d for example) are each connected to a respective (individual) inner conductor (302a, 302c, 302d for example) of the first set of transmission lines. These inner conductors are arranged consecutively in the outer conductor 302b between two of the low-band coupling elements 310a-b for the pairwise connected (consecutive) low-band radiating elements. Put differently, the transmission lines (including the respective portion of outer conductor 302b) for the high-band radiating elements 205a, 205c-d are arranged between the low-band coupling elements 210a-b.

The antenna feeding network further comprises first connector devices (312a, 312c, 312d for example, see FIG. 11) interconnecting inner conductors (302a, 302c, 302d, 302acd, 302cc for example, see FIG. 11) of the first set of transmission lines.

As can be seen in FIG. 11, a further connector device 312acd is connected to inner conductor 302acd and to inner conductor 302cc to act as a 3-way splitter/combiner splitting signals to the high-band radiating elements 305a, 305c-d or combining signals received from said high band elements. Further as can be seen in FIG. 11, inner conductor 302c of high-band radiating element 305c is connected via connector device 312c via an additional intermediate inner conductor 302cc to connecting device 312acd to achieve an overall electrical length between the splitting/combining point 302acd′ of connector device 312acd and radiating device 305c which corresponds to the overall electrical length between the splitting/combining point 302acd′ and the other high-band radiating elements 305a, 305d. The word corresponding here means that the electrical lengths are substantially the same, for example in the sense that the electrical length between the splitting/combining point 302acd′ and the radiating element 305a might differ by an amount delta compared with the electrical length between the splitting/combining point 302acd′ and the radiating element 305c, and the electrical length between the splitting/combining point 302acd′ and the radiating element 305c might differ by the same amount delta compared with electrical length between the splitting/combining point 302acd′ and the radiating element 305d to form a progressive phase shift. Such an arrangement would introduce a fixed electrical tilt of the antenna beam. Further as can be seen in FIG. 11, dielectric elements (314a for example) being displaceable by elongated rail elements are provided in a corresponding manner as described with reference to FIG. 1 and 4-5. The dielectric elements are U-shaped in a corresponding manner as in FIG. 1.

The antenna arrangement is provided with openings (313a, 313c, 313d for example) for each first connector device at the front side of the backplane 304a. The antenna arrangement is also provided with an opening 313b for example) for each second connector device (312b for example) at a rear side of the second set of transmission lines. The connector devices 312a, 312b, 312c, 312d are configured to interconnect the respective inner conductors capacitively and/or inductively.

Feeding networks for both polarizations of the dual polarized high band radiating elements are shown in FIG. 11, but the description above only describes the feeding network for one polarization as the function of the other side of the feeding network (for the other polarization) can be understood by analogy. For example, the second inner conductors 302a′, 302c′-d′ of the other side of the feeding network connected to the high-band radiating elements 305a, 305c-d are arranged between two of the (second) low-band coupling elements 310a′-b′ of the other side of the feeding network connected to the pairwise connected (consecutive) low-band radiating elements.

In other embodiments with different network topologies, one or more of the low-band radiating elements may be connected individually to a transmission line (i.e. not pairwise with another low-band radiating element as described above).

FIG. 12 can also be considered to show a front view of the embodiment in FIG. 10-11 since the only externally visible difference between the embodiments (the openings in the first set of transmission lines) are not shown in FIG. 12.

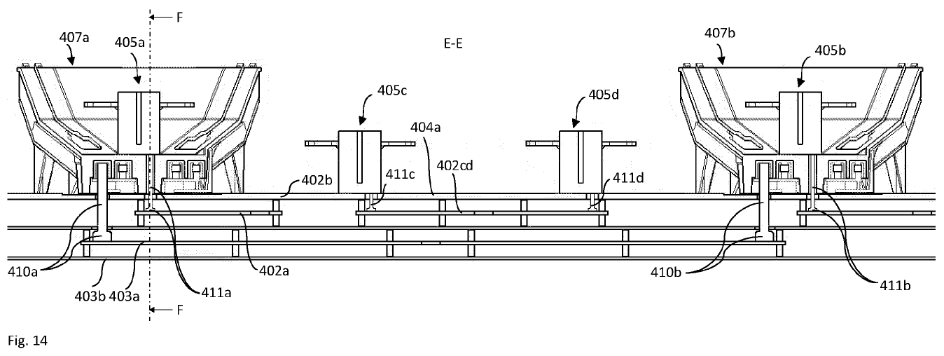

FIG. 13 shows a partial cross-section view of yet another embodiment of the antenna arrangement according to the invention, the cross-section being taken along a plane F-F (see FIG. 14) being perpendicular to the longitudinal/height direction of the antenna arrangement. FIG. 14 shows a partial cross-section view of the embodiment FIG. 13, the cross-section being taken along a plane E-E (see FIG. 13) being parallel with the longitudinal/height direction of the antenna arrangement.

The embodiment corresponds to the embodiment shown in FIG. 8-9 in the sense that it comprises the same sets of radiating elements (high-band radiating elements 405a-d and low-band radiating element 407a-b corresponding to ref. 205a-d and 207a-b in FIG. 8-9 can be seen in FIG. 13-14) but differs in that the antenna feeding network 401 comprises flat inner conductors (striplines). The first set of transmission lines 402 is located at a rear side of the backplane 404 between the backplane and a first plane 408 parallel to the backplane. The second set of transmission lines 403 is located between the first plane and a second plane 409 being parallel to the first plane. The first set of transmission lines 402 comprises transmission lines each comprising a flat inner conductor (402a for example) forming inner conductors, the flat inner conductors being placed in a respective compartment having conducting walls, the flat inner conductors interacting with two ground planes (402b, 402b′ for example) formed by said conducting walls. The second set of transmission lines 403 comprises transmission lines each comprising a flat inner conductor (403a for example) forming inner conductors, the flat inner conductors being placed in a respective compartment having conducting walls, the flat inner conductors interacting with two ground planes (403b, 403b′ for example) formed by said conducting walls. The flat inner conductors/striplines have the same function as the coaxial lines in FIG. 8-9. The spaces between the flat conductors/strips and the ground planes are substantially air filled. The first set of high-band radiating elements (405a-d for example) is connected to the first set of transmission lines 402 via coupling elements (411a-d for example) connecting to the flat inner conductors (402a, 402cd for example) thereof. The set of low-band radiating elements (407a-b for example) is connected to the second set of transmission lines 403 via coupling elements (410a-b for example) connecting to the flat inner conductors (403a for example) thereof. Dielectric elements (414a, 414b for example) are arranged in the compartments and form part of a phase shifting arrangement for adjusting the electrical tilt of the antenna arrangement.

The embodiment in FIG. 13-14 can be provided with optional additional flat inner conductors/striplines (415a-b for example) in separate compartments adjacent to the compartments in which the flat inner conductors connected to the low-band and high-band radiating elements are arranged. The additional flat inner conductors are connected to the flat inner conductors via connector devices (412a-b for example) arranged in respective openings in the backplane 404 and at the rear side of the second set of transmission lines in a corresponding manner as in FIGS. 1, 2, 8 and 10 such as to form an antenna feeding network. The connector devices may be configured to interconnect the respective inner conductors capacitively and/or inductively or via a direct electrical connection (galvanically). Dielectric elements may also be arranged in the compartments of the additional flat inner conductors in a corresponding manner as for example 414a, 414b to form part of a phase shifting arrangement for adjusting the electrical tilt of the antenna arrangement. The additional flat inner conductors form part of the first and second sets of transmission lines. For example, flat inner conductors 402a, 415a along with the respective compartment/outer conductors form part of the first set of transmission lines.

The embodiment in FIG. 13-14 corresponds to FIG. 8-9 in that the high-band only radiating elements (405c-d for example) arranged between the combined radiating elements (405a/407a, 405b/407b for example) are connected pairwise to a flat inner conductor (402cd for example).

In an alternative embodiment, the high-band only radiating elements (405c-d for example) arranged between the combined radiating elements (405a/407a, 405b/407b for example) may be connected to respective/individual flat inner conductors (i.e. for example 402cd is replaced with two separate flat inner conductors). Such an alternative embodiment will correspond to FIG. 10-11.

The embodiment in FIG. 7 may comprise additional flat inner conductors/striplines in a corresponding manner as shown in FIG. 13-14.

The description above and the appended drawings are to be considered as non-limiting examples of the invention. The person skilled in the art realizes that several changes and modifications may be made within the scope of the invention. For example, the number of coaxial lines may be varied, the number of radiating elements may be varied, the number of coaxial lines provided with rail elements may be varied, the number of coaxial lines provided with dielectric elements and/or support elements may be varied, and the number of radiating elements being part of combined radiating elements in relation to the number of low-band-only and high-band-only radiating elements may be varied. Furthermore, the backplane/reflector does not necessarily need to be formed integrally with the coaxial lines but may on the contrary be a separate element. Further, the high-and low-band radiating elements do not necessarily need to be dual-or cross-polarized. The scope of protection is determined by the appended patent claims.

1. An antenna arrangement, the antenna arrangement comprising:
an antenna feeding network comprising at least one first set of transmission lines and at least one second set of transmission lines, wherein the transmission lines of the at least one first and second sets of transmission lines comprise inner and outer conductors, and
at least one set of high-band radiating elements, and at least one set of low-band radiating elements, the radiating elements being arranged at a front side of a backplane (4a; 104) of the antenna arrangement,
wherein one or more of the at least one set of high-band radiating elements is each connected to one or more of the at least one first set of transmission lines, and wherein one or more of the at least one set of low-band radiating elements is each connected to one or more of the at least one second set of transmission lines,
wherein the at least one first set of transmission lines is located at a rear side of the backplane between the backplane and a first plane parallel to the backplane, and
wherein the at least one second set of transmission lines is located between the first plane and a second plane being parallel to the first plane.

2. The antenna arrangement according to claim 1, wherein at least two low-band radiating elements and at least two high-band radiating elements are arranged in a column to form an interleaved array of radiating elements.

3. The antenna arrangement according to claim 2, wherein at least two low-band radiating elements are connected to one or more inner conductors of transmission lines of the second set of transmission lines via at least one coupling element for each low-band radiating element, and wherein at least two consecutive high-band radiating elements are connected pairwise to at least one common inner conductor of respective transmission lines of the first set of transmission lines, the transmission lines for at least one pair of high-band radiating elements being arranged between two of said coupling elements.

4. The antenna arrangement according to claim 3, wherein at least one high-band radiating element of at least one pair of the high-band radiating elements being pairwise connected is formed together with a low-band radiating element as a combined radiating element having low-band radiating parts and high-band radiating parts.

5. The antenna arrangement according to claim 1, wherein the antenna feeding network further comprises at least one first connector device interconnecting inner conductors of at least two transmission lines of the first set of transmission lines, and at least one second connector device interconnecting inner conductors of at least two transmission lines of the second set of transmission lines wherein the antenna arrangement is provided with an opening for each first connector device at said front side of the backplane, and wherein the antenna arrangement is provided with an opening for each second connector device at a rear side of the second set of transmission lines.

6. The antenna arrangement according to claim 5, wherein the at least one first connector device is configured to interconnect inner conductors of at least two transmission lines of the first set of transmission lines capacitively and/or inductively, and/or wherein the at least one second connector device is configured to indirectly interconnect inner conductors of at least two transmission lines of the second set of transmission lines.

7. The antenna arrangement according to claim 1, comprising at least one combined radiating element, each combined radiating element having low-band radiating parts and high-band radiating parts such as to form one of the high-band radiating elements and one of the low-band radiating elements.

8. The antenna arrangement according to claim 1, wherein the inner conductor of at least one transmission line has a polygon-shaped cross section, such as a substantially circular or substantially rectangular cross section.

9. The antenna arrangement according to claim 1, wherein the space formed between the inner conductor and the outer conductor is substantially air-filled.

10. The antenna arrangement according to claim 1, wherein the outer conductor of at least one transmission line at least partially surrounds the inner conductor.

11. The antenna arrangement according to claim 1, wherein the first and second sets of transmission lines comprise parallel coaxial lines, each having its inner conductor at least partly surrounded by the outer conductor with air therebetween.

12. The antenna arrangement according to claim 1, wherein the first and/or second sets of transmission lines comprise at least one transmission line each comprising at least one ground plane forming at least part of the outer conductor and a flat inner conductor forming the inner conductor, said inner conductor interacting with the at least one ground plane.

13. The antenna arrangement according to claim 1, wherein the set of high-band radiating elements is configured to transmit and receive signals within one or more first frequency bands, the set of of low-band radiating elements being configured to transmit and receive signals within one or more second frequency bands having a center frequency F₂ being lower than a center frequency F₁ of said one or more first frequency bands.

14. The antenna arrangement according to claim 13, wherein the ratio F₁:F₂ is larger than 1.5:1, or larger than 2:1.

15. The antenna arrangement according to claim 1, further comprising a phase shifting arrangement being at least partly arranged in one or more outer conductors of at least one transmission line of the first and/or second set of transmission lines.

16. The antenna arrangement according to claim 15, wherein said phase shifting arrangement comprises at least one dielectric element being slidably arranged in said one or more outer conductors.

17. The antenna arrangement according to any of claim 1, wherein at least one transmission line of the first and/or second set of transmission lines is provided with an elongated rail element slidably arranged inside its outer conductor, said rail element being longitudinally movable in relation to said outer conductor, the elongated rail element being provided with at least one dielectric element configured to co-operate with the transmission line to provide a phase shifting arrangement.

18. The antenna arrangement according to claim 17, wherein at least one transmission line of the second set of transmission lines is provided with said elongated rail element, wherein the rail element is arranged in a front portion of the compartment formed by the outer conductor, the front portion being the portion of the compartment being closest to the first plane, the antenna arrangement further comprising means for adjusting the position of said rail element, the means for adjusting comprising a first connecting element slidably arranged in the outer conductor and being connected to the rail element, and a second connecting element connected to the first connecting element by means of extending through at least one longitudinally extending slot in the outer conductor.

19. The antenna arrangement according to claim 17, wherein at least one transmission line of the first set of transmission lines is provided with said elongated rail element, wherein the rail element is arranged at a rear portion of the compartment formed by the outer conductor, the antenna arrangement comprising means for adjusting the position of said rail element, wherein the means for adjusting comprises a third connecting element connected to the rail element by means of extending through a longitudinally extending slot of the outer conductor and through longitudinally extending slots in an adjacent outer conductor of a transmission line of the second set of transmission lines.

20. The antenna arrangement according to claim 2, wherein at least two low-band radiating elements are connected to inner conductors of transmission lines of the second set of transmission lines via at least one low-band coupling element for each low-band radiating element, and wherein at least two of the high-band radiating elements are connected to inner conductors of the first set of transmission lines via at least one high-band coupling element for each high-band radiating element, wherein the at least one high-band coupling element is arranged between low-band coupling elements of two consecutive low-band radiating elements.

21. The antenna arrangement according to claim 20, wherein the at least one low-band coupling element of at least one low-band radiating element is arranged between high-band coupling elements of two consecutive high-band radiating elements.

22. The antenna arrangement according to claim 20, wherein the high-band coupling elements of at least three consecutive high-band radiating elements are arranged between the low-band coupling elements of two consecutive low-band radiating elements.

23. The antenna arrangement according to claim 2, wherein at least two of the low-band radiating elements are connected to one or more inner conductors of transmission lines of the second set of transmission lines via at least one low-band coupling element for each low-band radiating element, wherein at least three consecutive high-band radiating elements are connected to at least two consecutive inner conductors of two or more transmission lines of the first set of transmission lines, each transmission line for the at least three consecutive high-band radiating elements being arranged between two of said low-band coupling elements.

24. The antenna arrangement according to claim 23, wherein the at least three consecutive high-band radiating elements are each connected to a respective consecutive inner conductor of three or more transmission lines of the first set of transmission lines.

25. The antenna arrangement according to claim 23, wherein the transmission lines for the at least three consecutive high-band radiating elements are arranged between two low-band coupling elements connecting two consecutive low-band radiating elements to a common inner conductor of a transmission line of the second set of transmission lines.

26. The antenna arrangement according to claim 22, wherein at least one high-band radiating element of the at least three high-band radiating elements is formed together with a low-band radiating element as a combined radiating element having low-band radiating parts and high-band radiating parts.
